(19) United States
(12) Patent Application Publication
(10) Pub. No.: US 2024/0258588 A1
(43) Pub. Date: Aug. 1, 2024

(54) BATTERY MANAGEMENT APPARATUS

(71) Applicant: Isuzu Motors Limited, Yokohama-shi (JP)

(72) Inventor: Takuya KIKUCHI, Fujisawa-shi (JP)

(73) Assignee: Isuzu Motors Limited, Yokohama-shi (JP)

(21) Appl. No.: 18/425,047

(22) Filed: Jan. 29, 2024

(30) Foreign Application Priority Data
Jan. 30, 2023 (JP) 2023-012168

(51) Int. Cl. H01M 10/42; B60L 58/22; B60R 16/033

(52) U.S. Cl. CPC H01M 10/425; H01M 10/4221; B60L 58/22; B60R 16/033; H01M 2010/4271; H01M 2220/20

(57) ABSTRACT

A battery management apparatus mounted in a vehicle, and configured to manage a plurality of battery packs connected in parallel, the battery management apparatus including an acquiring section configured to acquire battery pack information representing a charging amount and a voltage from each of the plurality of battery packs; a selection section configured to select a battery pack to be charged or a battery pack to be discharged from among the plurality of battery packs based on the battery pack information, and a control section configured to charge the battery pack to be charged in a charging mode and discharge the battery pack to be discharged in a discharging mode. When a mode is switched from the charging mode to the discharging mode, the control section performs a control such that the battery pack to be charged is used as it is as the battery pack to be discharged.

### CROSS REFERENCE TO RELATED APPLICATIONS

This application claims the benefit of priority of Japanese Patent Application No. 2023-012168, filed on Jan. 30, 2023, the contents of which are incorporated by reference as if fully set forth herein in their entirety.

### TECHNICAL FIELD

The present disclosure relates to a battery management apparatus.

### BACKGROUND ART

In the related art, a system is known in which in an automobile a plurality of battery packs is connected in parallel, and a BMS (Battery Management System) mounted in each battery pack performs a CAN (Controller Area Network) communication with a higher-level controller (see, for example, PTL 1).

In the above-mentioned system, it is known to select the combination of the battery packs used, in accordance with the charging mode of charging the battery pack and the discharging mode of discharging from the battery pack.

In addition, it is known that in the above-mentioned system, the available total charging amount (which may be referred to also as total residual quantity) of the battery pack is notified to the user (for example, the passenger of the automobile) through image display and the like. In the following description, the available total charging amount of the battery pack may be simply referred to as “total charging amount”.

### CITATION LIST

### Patent Literature

### PTL 1

Japanese Unexamined Patent Application Publication (Translation of PCT Application) No. 2019-532605

### SUMMARY OF INVENTION

### Technical Problem

In the above-mentioned system, however, when the mode is switched from the charging mode to the discharging mode, the total charging amount notified to the user may unnaturally change, making the user feel uncomfortable.

An object of an aspect of the present disclosure is to provide a battery management apparatus that can eliminate the risk of making the user feel uncomfortable.

### Solution to Problem

A battery management apparatus according to an aspect of the present disclosure is mounted in a vehicle, and configured to manage a plurality of battery packs connected in parallel, the battery management apparatus including an acquiring section configured to acquire battery pack information representing a charging amount and a voltage from each of the plurality of battery packs; a selection section configured to select a battery pack to be charged or a battery pack to be discharged from among the plurality of battery packs based on the battery pack information, and a control section configured to charge the battery pack to be charged in a charging mode and discharge the battery pack to be discharged in a discharging mode. When a mode is switched from the charging mode to the discharging mode, the control section performs a control such that the battery pack to be charged is used as it is as the battery pack to be discharged.

### Advantageous Effects of Invention

According to the present disclosure, it is possible to eliminate the risk of making the user feel uncomfortable.

### BRIEF DESCRIPTION OF DRAWINGS

FIG. 1 is a schematic view illustrating a configuration of a battery pack system according to an embodiment of the present disclosure; and

FIG. 2 is a block diagram illustrating a configuration of an MBMS according to the embodiment of the present disclosure.

### DESCRIPTION OF EMBODIMENTS

An embodiment of the present disclosure is described below with reference to the drawings.

### Basic Configuration

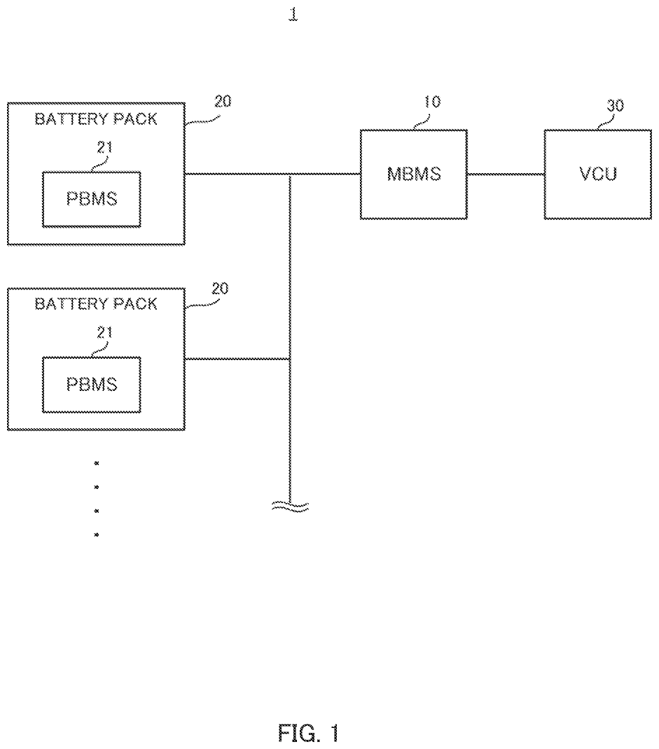

First, a configuration of battery pack system 1 is described with reference to FIG. 1. FIG. 1 is a schematic view illustrating an exemplary configuration of battery pack system 1.

Battery pack system 1 illustrated in FIG. 1 is mounted in a vehicle (for example, an electric vehicle).

Battery pack system 1 includes one MBMS (Master Battery Management System) 10, a plurality of battery packs 20, and one VCU (Vehicle Control Unit) 30.

The plurality of battery packs 20 is connected in parallel. Each battery pack 20 includes a PBMS (Pack Battery Management System) 21. Although not illustrated in the drawings, each battery pack 20 includes a rechargeable/dischargeable secondary battery, a high-voltage relay (for example, a positive electrode side relay and a negative electrode side relay), a resistor, a voltmeter, an ammeter and the like.

VCU 30 is a computer that generally controls the automobile. VCU 30 corresponds to the higher-level computer (controller) of MBMS 10.

MBMS 10 is a computer that mainly manages each battery pack 20. Note that MBMS 10 corresponds to an example of “battery management apparatus”.

PBMS 21 is a computer that mainly monitors the state of battery pack 20, and controls the driving of the high-voltage relay. Examples of the state of battery pack 20 include the current, voltage, temperature, degree of degradation, charging amount (SOC: State Of Charge) and the like in battery pack 20.

MBMS 10 and each of VCU 30 and PBMS 21 perform CAN (Controller Area Network) communications.

A configuration of battery pack system 1 is described above.

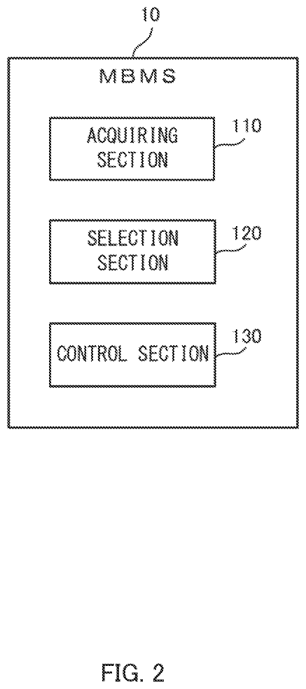

Next, a configuration of MBMS 10 is described with reference to FIG. 2. FIG. 2 is a block diagram illustrating an exemplary configuration of MBMS 10.

Although not illustrated in the drawings, MBMS 10 includes, as hardware, a CPU (Central Processing Unit), a ROM (Read Only Memory) storing a computer program, a RAM (Random Access Memory) serving as a work memory and the like, for example. The following functions are implemented when the CPU executes computer programs read from the ROM at the RAM.

As illustrated in FIG. 2, MBMS 10 includes acquiring section 110, selection section 120, and control section 130. Note that VCU 30 may execute a part or all of the control of control section 130.

Acquiring section 110 acquires battery pack information from each of the plurality of battery packs 20 (more specifically, PBMS 21).

The battery pack information is information representing the above-described state of battery pack 20. In the exemplary operations 1 to 3, the battery pack information is information representing at least the charging amount and voltage. In addition, the battery pack information includes information that can identify battery pack 20 (for example, ID). This battery pack information is used by selection section 120 described later.

In addition, acquiring section 110 acquires mode information from VCU 30. The mode information includes the charging mode and the discharging mode.

Selection section 120 and control section 130 described later can recognize the mode information when acquiring section 110 acquires the mode information.

The charging mode is a mode of performing the charging of battery pack 20 by supplying the power from an external power source not illustrated to a predetermined battery pack 20 (the battery pack to be charged described later). The charging mode is executed when the external power source and the predetermined battery pack 20 are electrically connected to each other.

The discharging mode is a mode of discharging battery pack 20 by supplying power from a predetermined battery pack 20 (the battery pack to be discharged described later) to a load (for example, a travelling motor or the like) not illustrated. The discharging mode is executed when key-on is performed by the user, for example.

Selection section 120 selects the battery pack to be charged or the battery pack to be discharged from among the plurality of battery packs 20 on the basis of the battery pack information.

The battery pack to be charged is battery pack 20 for which charging is performed in the charging mode. The battery pack to be discharged is battery pack 20 for which discharging is performed in the discharging mode.

A method of selecting the battery pack to be charged is elaborated below.

First, selection section 120 specifies battery pack 20 with the smallest charging amount (hereinafter referred to as smallest charging amount battery pack) from among the plurality of battery packs 20 on the basis of the battery pack information. Next, selection section 120 specifies battery pack 20 with a voltage within a predetermined value (hereinafter referred to as battery pack within the predetermined value) with respect to the voltage of smallest charging amount battery pack 20 on the basis of the battery pack information. Selection section 120 determines, to be a first battery pack to be charged, the smallest charging amount battery pack and the battery pack within the predetermined value. In addition, selection section 120 determines, to be a second battery pack to be charged, battery pack 20 that is not selected as the first battery pack to be charged (for example, battery pack 20 with a voltage greater than the predetermined value).

Details are further described below. For example, it is assumed that the plurality of battery packs 20 are five battery packs A to E, and that the predetermined value is 10 V. Here, for example, in the case where the charging amount of battery pack A is smallest, the charging amount of battery pack B is largest, and the voltages of battery packs C to E are voltages within 10 V from the voltage of battery pack A, battery packs A and C to E are determined to be the first battery pack to be charged, and battery pack B is determined to be the second battery pack to be charged. Note that examples of the charging method are described later.

A method of selecting the battery pack to be discharged is elaborated below.

First, selection section 120 specifies combinations of battery packs 20 with a voltage difference within a predetermined value. Next, selection section 120 selects the combination with the largest available total charging amount of battery pack 20 from among the specified combinations. Then, selection section 120 determines battery pack 20 included in the selected combination to be the battery pack to be discharged.

Details are further described below. For example, it is assumed that the plurality of battery packs 20 are five battery packs A to E, and that the predetermined value is 10 V. Here, for example, in the case where a first combination composed of battery packs C to E with an available total charging amount of battery pack 20 of TA1 (kWh), and a second combination composed of battery packs A to D with a total charging amount of TA2 (kWh) are specified as combinations with a voltage difference within 10 V (TA2>TA1), the second combination with the larger total charging amount is selected, and battery packs A to D included therein are determined to be the battery pack to be discharged.

Note that battery pack 20 that has not been selected as the battery pack to be discharged is referred to as “battery pack not to be discharged”.

In addition, when selecting the above-described battery pack to be discharged, selection section 120 calculates the available total charging amount of battery pack 20 (and the travelling distance based on it, etc.) among the plurality of battery packs 20 on the basis of the battery pack information, and the calculated value is displayed on the display section inside the vehicle.

In the charging mode, control section 130 assigns, to the battery pack to be charged, battery packs 20 including battery pack 20 with the smallest charging amount (the above-described battery pack A), and battery pack 20 with a potential difference within a predetermined value from battery pack 20 with the smallest charging amount, among the plurality of battery packs 20. In the discharging mode, control section 130 assigns, to the battery pack to be discharged, battery packs 20 included in the combination with the largest available total charging amount, among the combinations of battery packs 20 with a potential difference within a predetermined value among the plurality of battery packs 20. More specifically, control section 130 transmits assignment information to each PBMS 21. Each PBMS 21 executes charging or discharging (for example, on/off of the relay) of the assigned battery pack 20 on the basis of the assignment information received from control section 130.

A method of charging the battery pack to be charged is elaborated below. Note that in the following description, control section 130 executes the control of charging battery pack 20, but a part or all of the control executed by control section 130 may be executed by VCU 30.

First, control section 130 starts the charging of the first battery pack to be charged. Thereafter, when the charging amount of the first battery pack to be charged reaches the charging amount of the second battery pack to be charged, control section 130 starts the charging of the second battery pack to be charged together with the charging of the first battery pack to be charged. Then, control section 130 executes the charging until the charging amounts of all of the first battery pack to be charged and the second battery pack to be charged become the fully charged state.

Details are further described below. It is assumed that as described above battery packs A and C to E are determined to be the first battery pack to be charged, and that battery pack B is determined to be the second battery pack to be charged, for example. In this case, first, the charging of battery packs A and C to E is started. Then, when the charging amount of each of battery packs A and C to E reaches the charging amount of battery pack B, the charging of battery packs A to E is started. This charging is executed until the charging amount of each of battery packs A to E becomes the fully charged state.

A configuration of MBMS 10 is described above.

The operation of the above-described MBMS 10 is a basic operation. Characteristic operations of MBMS 10 are described below.

### Exemplary Operation 1

As described above, battery packs 20 including battery pack 20 with the smallest charging amount (the above-described battery pack A), and battery packs 20 with a potential difference within the predetermined value from battery pack 20 with the smallest charging amount are determined to be the battery pack to be charged, among the plurality of battery packs 20. On the other hand, battery packs 20 included in the combination with the largest available total charging amount of battery pack 20 are determined to be the battery pack to be discharged, among the combinations of battery packs 20 with a potential difference within the predetermined value among the plurality of battery packs 20. As such, for example, when the mode is switched from the charging mode to the discharging mode, the available total charging amount of battery pack 20 may change due to the change of the combination of the battery packs used. As a result, the total charging amount notified to the user may unnaturally change, thus causing the risk of making the user feel uncomfortable.

In view of this, control section 130 may perform the control such that when the charging mode is switched to the discharging mode, the combination of the battery pack to be charged selected in the charging mode is used as it is as the combination of the battery pack to be discharged, for example.

In this manner, in exemplary operation 1, when the charging mode is switched to the discharging mode, the change of the total charging amount due to the change of the combination of the battery packs used can be suppressed, and the unnatural change of the total charging amount notified to the user (and the travelling distance based on it, etc.) can be suppressed, thus eliminating the risk of making the user feel uncomfortable.

### Exemplary Operation 2

For example, in the case where a configuration of selecting the battery pack to be charged only at key-on is employed, even when there is a selectable battery pack to be charged at the time when the mode is switched from the discharging mode to the charging mode, that battery pack cannot be added, and consequently the charging cannot be efficiently performed.

In view of this, when the voltage difference between the battery pack to be discharged and the battery pack not to be discharged is greater than a predetermined value, and the voltage of the battery pack to be discharged is greater than the voltage of the battery pack not to be discharged at the time when the mode is switched from the discharging mode to the charging mode, selection section 120 may select the battery pack to be discharged as the battery pack to be charged, and control section 130 may charge the selected battery pack to be charged to the fully charged state.

Details are further described below. The following describes an exemplary case where the plurality of battery packs 20 are five battery packs A to E, battery packs A to D are the battery pack to be discharged, and battery pack E is the battery pack not to be discharged. Here, when the difference between the voltage of battery packs A to D and the voltage of battery pack E is greater than a predetermined value, and the voltage of battery packs A to D is greater than the voltage of battery pack E at the time when the mode is switched from the discharging mode to the charging mode, battery packs A to D excluding battery pack E are selected as the battery pack to be charged. Then, each of battery packs A to D is charged to the fully charged state.

On the other hand, when the voltage difference between the battery pack to be discharged and the battery pack not to be discharged is within a predetermined value, and the voltage of the battery pack to be discharged is smaller than the voltage of the battery pack not to be discharged at the time when the mode is switched from the discharging mode to the charging mode, selection section 120 may select both the battery pack to be discharged and the battery pack not to be discharged as the battery pack to be charged, and control section 130 may charge the selected battery pack to be charged to the fully charged state.

Details are further described below. The following describes an exemplary case where the plurality of battery packs 20 are five battery packs A to E, battery packs A to D are the battery pack to be discharged, and battery pack E is the battery pack not to be discharged. In this case, when the voltage difference between the voltage of battery packs A to D and the voltage of battery pack E is within a predetermined value, and the voltage of battery packs A to D is smaller than the voltage of battery pack E at the time when the mode is switched from the discharging mode to the charging mode, battery packs A to E are selected as the battery pack to be charged. For example, battery packs A to D are determined to be the first battery pack to be charged, and battery pack E is determined to be the second battery pack to be charged. Then, the above-described “method of charging the battery pack to be charged” is performed, and each of battery packs A to E is finally charged to the fully charged state.

Thus, in exemplary operation 2, the charging can be efficiently performed when the mode is switched from the discharging mode to the charging mode.

### Exemplary Operation 3

For example, if discharging (for example, travelling of the automobile) is started and the battery pack not to be discharged is added to the battery pack to be discharged during the discharging in the state where not all of a plurality of battery packs is selected as the battery pack to be discharged (in other words, the state where some of the plurality of battery packs 20 are the battery pack not to be discharged), the values such as the total charging amount and the travelable distance notified to the user unnaturally change, thus causing the risk of making the user feel uncomfortable.

In view of this, first, control section 130 does not change the battery pack not to be discharged set when starting the operation in the discharging mode, to the battery pack to be discharged during the operation in the discharging mode. That is, even when the voltage difference between the battery pack not to be discharged and the battery pack to be discharged falls within a predetermined value as a result of the discharging from the battery pack to be discharged set when starting the operation in the discharging mode, control section 130 does not add the battery pack not to be discharged, to the battery pack to be discharged. In this manner, by adding the battery pack not to be discharged to the battery pack to be discharged during the discharging, unnatural change in the values such as the total charging amount and the travelable distance notified to the user can be suppressed.

Note that in the case where the operation of the vehicle is restarted by the key-on operation after the vehicle stops the operation due to key-off operation during the operation in the discharging mode, the battery pack not to be discharged may be allowed to be added to the battery pack to be discharged even during the operation in the discharging mode. A reason for this is that in the case where a vehicle stop operation is interposed, the user is less made feel uncomfortable even when the battery pack to be discharged changes and the values such as the total charging amount and the travelable distance notified to the user change before and after the vehicle stop, even during the operation in the discharging mode. In addition, allowing the battery pack not to be discharged, to be added to the battery pack to be discharged is advantageous in that the total charging amount and the travelable distance can be increased.

On the other hand, control section 130 allows the battery pack not to be charged set when starting the operation in the charging mode, to be changed to the battery pack to be charged during the operation in the charging mode. More specifically, when the voltage difference between the battery pack not to be charged and the battery pack to be charged falls within a predetermined value as a result of execution of charging to the battery pack to be charged in the charging mode, the battery pack not to be charged is added to the battery pack to be charged.

When not all of the plurality of battery packs 20 has not been selected as the battery pack to be discharged at the time when the mode is switched from the charging mode to the discharging mode, control section 130 may estimate a total charging amount that is obtained when assuming that the battery pack not to be discharged is added to the battery pack to be discharged on the basis of the battery pack information during the discharging mode. Next, control section 130 may prohibit the addition of the battery pack not to be discharged, to the battery pack to be discharged when the estimated total charging amount is greater than the current total charging amount.

Thus, according to exemplary operation 3, the unnatural change of the total charging amount notified to the user (and the travelling distance based on it, etc.) can be suppressed, thus eliminating the risk of making the user feel uncomfortable.

The present disclosure is not limited to the description of the above embodiments, and various variations are possible to the extent that the intent is not departed from. For example, in MBMS 10, all of the operations described in exemplary operations 1 to 3 may be implemented such that any of operations is selectively employed.

### INDUSTRIAL APPLICABILITY

The battery management apparatus of the present disclosure is suitable for a case where a plurality of battery packs is used.

1. A battery management apparatus mounted in a vehicle, and configured to manage a plurality of battery packs connected in parallel, the battery management apparatus comprising:
an acquiring section configured to acquire battery pack information representing a charging amount and a voltage from each of the plurality of battery packs;
a selection section configured to select a battery pack to be charged or a battery pack to be discharged from among the plurality of battery packs based on the battery pack information, and
a control section configured to charge the battery pack to be charged in a charging mode and discharge the battery pack to be discharged in a discharging mode, wherein
when a mode is switched from the charging mode to the discharging mode, the control section performs a control such that the battery pack to be charged is used as it is as the battery pack to be discharged.

2. The battery management apparatus according to claim 1,
wherein in the charging mode,
the selection section determines, to be a first battery pack to be charged, a battery pack with a voltage within a predetermined value with respect to a voltage of a battery pack with a smallest charging amount among the plurality of battery packs, and determines, to be a second battery pack to be charged, a battery pack with a voltage greater than the predetermined value, and
the control section starts charging of the first battery pack to be charged first, and then executes charging of the second battery pack to be charged together with the charging of the first battery pack to be charged when a charging amount of the first battery pack to be charged reaches a charging amount of the second battery pack to be charged, and
wherein in the discharging mode,
the selection section selects a combination with a largest total charging amount from among combinations of battery packs with a voltage difference within the predetermined value, and determines, to be the battery pack to be discharged, the battery packs included in the combination, and
the control section executes discharging of the battery pack to be discharged.
